(19) United States
(12) Patent Application Publication
(10) Pub. No.: US 2019/0177826 A1
(43) Pub. Date: Jun. 13, 2019

(54) Systems and Methods Implementing Wear-Resistant Copper-Based Materials

(71) Applicant: California Institute of Technology, Pasadena, CA (US)

(72) Inventors: Douglas C. Hofmann, Altadena, CA (US); Andrew Kennett, Montrose, CA (US)

(73) Assignee: California Institute of Technology, Pasadena, CA (US)

(21) Appl. No.: 16/280,374

(22) Filed: Feb. 20, 2019

Related U.S. Application Data
(63) Continuation of application No. 15/530,413, filed on Jan. 9, 2017.
Application No. 15/530,413 is a continuation of application No. 14/041,960, filed on Sep. 30, 2013, now abandoned.
(60) Provisional application No. 61/707,258, filed on Sep. 28, 2012.

(51) Int. Cl. C22C 45/10; F16H 55/17; F16H 55/06; C22C 9/00; F16H 57/00; C22C 16/00

(52) U.S. Cl. CPC C22C 45/10; F16H 55/17; F16H 55/06; Y10T 428/211; F16H 57/00; C22C 16/00; Y10T 29/49462; C22C 9/00

(57) ABSTRACT

Systems and methods in accordance with embodiments of the invention implement copper-based materials in applications where resistance to wear is desired. In one embodiment, a wear-resistant gear includes a gear defined by a rotatable body having teeth disposed on an outer surface of the rotatable body, where the gear body is formed at least in part from a material including copper and X, where X is one of zirconium, titanium, hafnium, rutherfordium, and mixtures thereof and where the atomic ratio of copper to X is approximately between 2:3 and 3:2.

### CROSS-REFERENCE TO RELATED APPLICATIONS

The current application is a continuation of U.S. patent application Ser. No. 15/530,413, filed Jan. 9, 2017, which application is a continuation of U.S. patent application Ser. No. 14/041,960, filed Sep. 30, 2013, which application claims priority to U.S. Provisional Application No. 61/707,258, filed Sep. 28, 2012, the disclosures of which are incorporated herein by reference in their entirety.

### STATEMENT OF FEDERAL FUNDING

The invention described herein was made in the performance of work under a NASA contract, and is subject to the provisions of Public Law 96-517 (35 U.S.C. 202) in which the Contractor has elected to retain title.

### FIELD OF THE INVENTION

The present invention generally relates to materials for use in applications where resistance to wear is desired.

### BACKGROUND

In many engineering applications, it is desirable for constituent components to be sufficiently resistant to ‘wear.’ To be clear, ‘wear’ conventionally refers to the displacement of the surface of a material as a direct result of its mechanical interaction with another material. There exist several types of wear. For example, ‘abrasive wear’ is where a rough, hard material gouges or troughs a softer one during a mechanical interaction. ‘Adhesive wear,’ or galling, is where the mechanical interaction between two materials results in material from one material to another. ‘Corrosive wear’ is where a material is adversely impacted by chemical interactions, e.g., corrosion, such that the material becomes more susceptible to, for example, abrasive wear or galling.

A component's resistance to wear is largely a function of its constituent material; in other words, constituent materials have inherent wear characteristics. Accordingly, much effort has been directed to determining and studying the wear characteristics of materials to identify which materials are best suited for applications where resistance to wear is desired. The determination and studying of wear characteristics of materials is known as tribology. Because of the efforts in tribology, the current state of the art has a fair understanding of the nature of wear. For example, it is currently generally understood that a material's resistance to wear tends to increase with its hardness, i.e., the harder a material is, the less susceptible it is to wear. (See e.g., I. L. Singer, Wear, Volume 195, Issues 1-2, July 1996, Pages 7-20, the disclosure of which is herein incorporated by reference.) Thus, in accordance with this current understanding, it is generally advisable to implement relatively harder materials in applications where resistance to wear is desired.

Still, although certain materials have been identified as being suitable for applications where resistance to wear is desired, these materials may still wear to some extent. In many instances, it would be desirable to employ materials that are more resilient against wear. Accordingly, there exists a need to develop a fuller understanding of the nature of wear such that materials that have improved resistance to wear can be developed and used to form higher quality components.

### SUMMARY OF THE INVENTION

Systems and methods in accordance with embodiments of the invention implement copper-based materials in applications where resistance to wear is desired. In one embodiment, a wear-resistant gear includes a gear defined by a rotatable body having teeth disposed on an outer surface of the rotatable body, where the gear is formed at least in part from a material including copper and X, where X is one of zirconium, titanium, hafnium, rutherfordium, and mixtures thereof, and where the atomic ratio of copper to X is approximately between 2:3 and 3:2.

In another embodiment, the atomic ratio of copper to X is approximately between 9:11 and 11:9.

In yet another embodiment, at least the teeth of the gear are formed from the material.

In still another embodiment, X is zirconium.

In still yet another embodiment, the material further includes Al and Be, where Al is present between approximately 3 atomic % and 10 atomic %, and where Be is present between approximately 3 atomic % and 10 atomic %.

In a further embodiment, the material further includes one of: Be, Ti, Cr, Fe, Co, Ni, Zn, Al, B, C, Si, P, Y, b, Mo, Pd, Ag, Sn, Sb, Hf, Ta, W, Pt, Au, and mixtures thereof.

In a yet further embodiment, the material is one of: Cu₄₃Zr₄₃Al₇Be₇, Cu₄₀Zr₄₀Al₁₀, Be₁₀Cu_{39.77}Zr_{40.74}Al_{6.79}Be_{9.7}Nb₃, Cu_{45.6}Zr_{44.6}Al_{4.9}Y_{1.9}Nb₃, Cu_{42.7}Zr_{42.7}Al_{6.8}Be_{4.9}Nb₃, Cu_{41.7}Zr_{41.7}Al_{6.8}Be_{6.8}Nb₃, Cu₄₀Zr₄₀Al₁₀Be₁₀, Cu₄₁Zr₄₀Al₇Be₇Co₅, Cu₄₂Zr₄₁Al₇Be₇Co₃, Cu_{47.5}Zr₄₈Al₄Co_{0.5}, Cu₄₇Zr₄₆Al₅Y₂, Cu₅₀Zr₅₀, Cu₄₂Zr₄₁Al₇Be₇Cr₃, Cu₄₄Zr₄₄Al₅Ni₃Be₄, Cu_{46.5}Zr_{46.5}Al₇, Cu₄₃Zr₄₃Al₇Ag₇, Cu_{41.5}Zr_{41.5}Al₇Be₁₀, Cu₄₄Zr₄₄Al₇Be₅, Cu₄₃Zr₄₃Al₇Be₇, Cu₄₄Zr₄₄Al₇Ni₅.

In a still further embodiment, the material is fully crystalline.

In a still yet further embodiment, the material is fully amorphous.

In another embodiment, the material is partially crystalline and partially amorphous.

In yet another embodiment, the material includes a slow-forming tarnish oxide layer.

In a further embodiment, a method of fabricating a wear-resistant gear includes: selecting a material from which to form the gear, where the material includes copper and X, where X is one of zirconium, titanium, hafnium, rutherfordium, and mixtures thereof, and where the atomic ratio of copper to X is approximately between 2:3 and 3:2; and fabricating at least part of the gear from the selected material, where the gear is defined by a rotatable body having teeth disposed on an outer surface of the rotatable body.

In a yet further embodiment, the atomic ratio of copper to X is approximately between 9:11 and 11:9.

In a still further embodiment, the teeth of the gear are fabricated from the selected material.

In a still yet further embodiment, X is zirconium.

In another embodiment, the material further includes Al and Be, where Al is present between approximately 3 atomic % and 10 atomic %, and where Be is present between approximately 3 atomic % and 10 atomic %.

In yet another embodiment, a material with an atomic % of aluminum that corresponds with the desired hardness value is selected.

In still another embodiment, the material further includes one of: Be, Ti, Cr, Fe, Co, Ni, Zn, Al, B, C, Si, P, Y, b, Mo, Pd, Ag, Sn, Sb, Hf, Ta, W, Pt, Au, and mixtures thereof.

In still yet another embodiment, the material is one of: Cu₄₃Zr₄₃Al₇Be₇, Cu₄₀Zr₄₀Al₁₀, Be₁₀Cu_{39.77}Zr_{40.74}Al_{6.79}Be_{9.7}Nb₃, Cu_{45.6}Zr_{44.6}Al_{4.9}Y_{1.9}Nb₃, Cu_{42.7}Zr_{42.7}Al_{6.8}Be_{4.9}Nb₃, Cu_{41.7}Zr_{41.7}Al_{6.8}Be_{6.8}Nb₃, Cu₄₀Zr₄₀Al₁₀Be₁₀, Cu₄₁Zr₄₀Al₇Be₇Co₅, Cu₄₂Zr₄₁Al₇Be₇Co₃, Cu_{47.5}Zr₄₈Al₄Co_{0.5}, Cu₄₇Zr₄₆Al₅Y₂, Cu₅₀Zr₅₀, Cu₄₂Zr₄₁Al₇Be₇Cr₃, Cu₄₄Zr₄₄Al₅Ni₃Be₄, Cu_{46.5}Zr_{46.5}Al₇, Cu₄₃Zr₄₃Al₇Ag₇, Cu_{41.5}Zr_{41.5}Al₇Be₁₀, Cu₄₄Zr₄₄Al₇Be₅, Cu₄₃Zr₄₃Al₇Be₇, Cu₄₄Zr₄₄Al₇Ni₅.

In a further embodiment, the material is fully crystalline.

In a still further embodiment, the material is fully amorphous.

In a yet further embodiment, the material is partially crystalline and partially amorphous.

In a still yet further embodiment, the material includes a slow-forming tarnish oxide layer.

In another embodiment, a method of improving the performance of a device that includes components that are subject to wear-causing processes includes: identifying a component that is subject to a wear-causing process; and modifying the design of the component such that the component is subject to the wear-causing process in at least a partial vacuum.

### BRIEF DESCRIPTION OF THE DRAWINGS

FIG. 1 illustrates the pin-on-disk method that is virtually standardized in assessing a material's wear performance.

FIG. 2 illustrates the wear resistance of several materials as a function of hardness.

FIG. 3 illustrates the conventional understanding of how wear performance generally varies as a function of hardness.

FIG. 4 illustrates an Ashby plot identifying generalized wear performance and hardness values for several classes of material

FIG. 5 illustrates the wear-performance of copper-zirconium based materials relative to titanium BMG-based materials and relative to zirconium BMG-based materials.

FIGS. 6A-6C illustrate the profilometry of a copper-zirconium BMG relative to a Vascomax steel and a zirconium-based BMG, after the respective samples had been subject to pin-on-disk testing.

FIGS. 7A-71 illustrate XRD results for a variety of copper-zirconium based materials in accordance with embodiments of the invention.

FIGS. 8A-8B illustrate how a base copper-zirconium material can be alloyed to vary certain of the base material's mechanical properties without greatly deteriorating the wear performance in accordance with embodiments of the invention.

FIG. 9 illustrates an Ashby plot that conveys a generalized understanding of the wear-performance of metals, BMGs, and ceramics relative to copper-based materials in accordance with embodiments of the invention.

FIG. 10A illustrates a copper-zirconium phase diagram.

FIG. 10B illustrates a copper-titanium phase diagram.

FIGS. 11A-11B illustrate XPS plots that confirm the existence of an oxide layer for a copper-zirconium based material as well as a zirconium BMG-based material.

FIG. 12 illustrates how the wear performance characteristics of a copper-zirconium BMG-based alloy and a zirconium BMG-based alloy vary as a function of pressure.

FIG. 13 illustrates a method of improving the performance of a device that includes components that are subject to wear-causing processes.

FIG. 14 provides a general schematic of a copper-group IV material in accordance with embodiments of the invention.

FIG. 15 illustrates a gear which can be formed in accordance with embodiments of the invention.

FIGS. 16A-16C illustrate the general testing setup used to confirm the efficacy of gears fabricated from copper-group IV metals in accordance with embodiments of the invention.

FIG. 17 illustrates the results of testing gears that were fabricated from CuZrAlBe material in accordance with embodiments of the invention.

FIG. 18 illustrates data that show that CuZrAlBe BMG-based materials are sufficiently wear-resistant in spite of their low fracture toughness.

FIGS. 19A-19B depict before and after pictures of a gear fabricated from a CuZrAlBe BMG-based material that was subjected to a gear-on-gear test.

FIGS. 20A-20B depict the profilometry of a gear fabricated from a CuZrAlBe BMG-based material that was subjected to a gear-on-gear test relative to that of a gear fabricated from a Vascomax steel that was subjected to the same gear-on-gear test.

FIG. 21 illustrates a method of fabricating a gear in accordance with embodiments of the invention.

### DETAILED DESCRIPTION

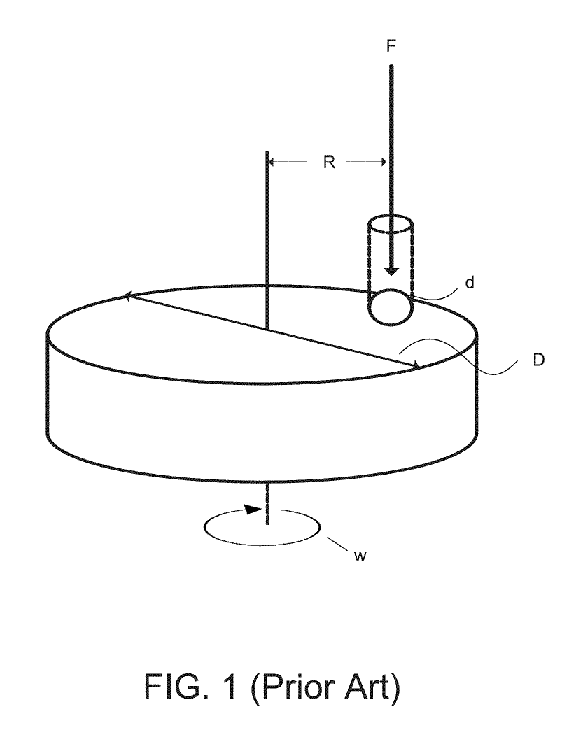

Turning now to the drawings, systems and methods for implementing copper-based materials that demonstrate superior wear performance are illustrated. As mentioned above, resistance to wear is largely an inherent material property. A particular material's resistance to wear can be determined by subjecting a sample of the material to a process that causes wear, and measuring the mass of the sample before and after the ‘wear-causing’ process. For example, FIG. 1 depicts a pin-on-disk setup that is standard in determining a material's resistance to wear. In the illustration, a sphere with a diameter, d, is applied with a force, F, to a disk with a diameter, D. The force, F, is applied at a radial distance, R, from the disk's center. The disk is then rotated through w revolutions as the force, F, is being applied. In this case, the sphere being applied with a force on the disk causes wear. The mass of the disk is determined before and after it has been subjected to the force F. Accordingly, the difference in mass reflects the amount of material that was ‘worn away’ by the process, i.e., the ‘wear loss’. And of course, wear loss is inversely correlated with wear resistance; in other words, the more a material wears away, the less resistant it is to wear loss.

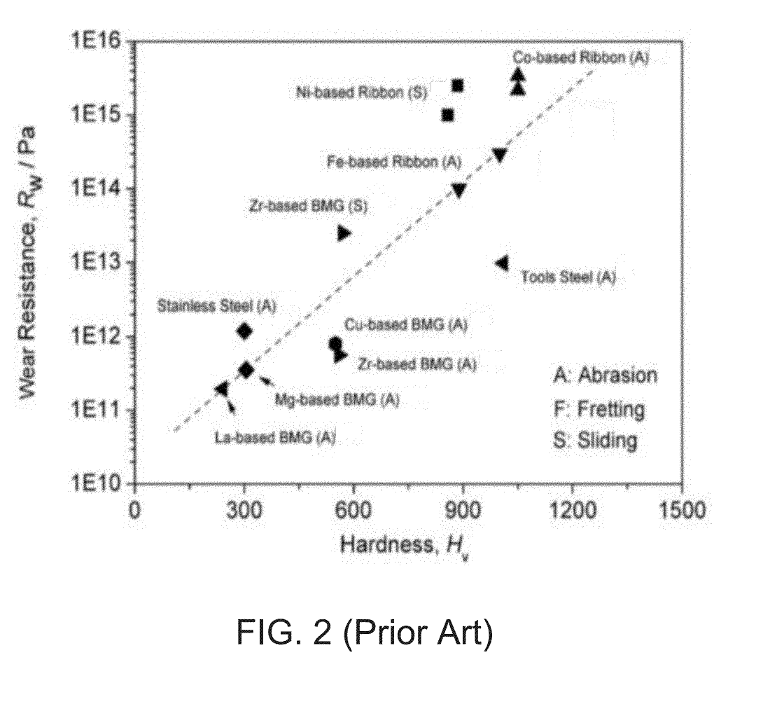

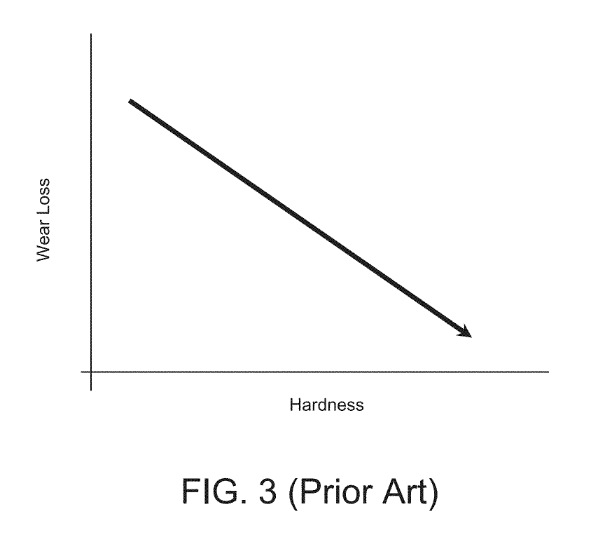

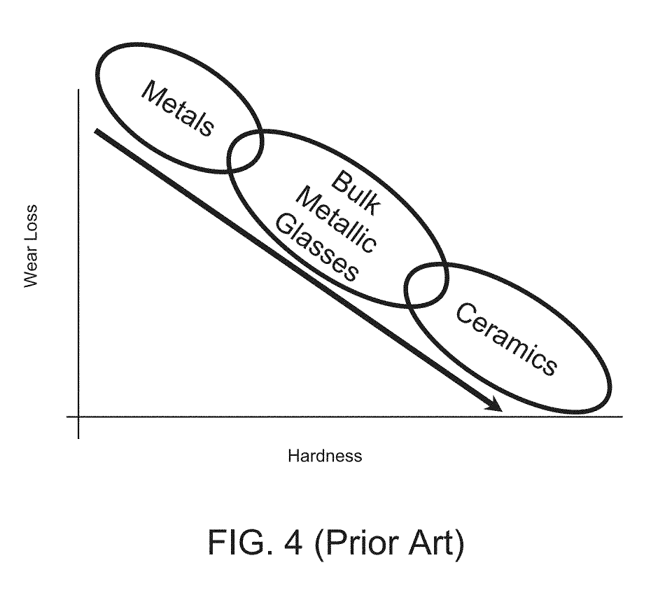

FIG. 2 depicts a plot that illustrates the wear resistance of several materials as a function of hardness. In particular, wear resistance (R_{W} in the plot) is defined by SN/V_{W}, where S is the total sliding distance, N is the normal load, and V_{W} is the total volume of material removed by wear. R_{W} has units of Pa. This information is obtained from International Materials Reviews, Volume 47, Number 2, April 2002, pgs. 87-112(26), “Wear Resistance of Amorphous Alloys and Related Materials,” by A L Greer, the disclosure of which is hereby incorporated by reference. Note that the plot conveys a positive correlation between wear resistance and hardness, i.e., harder materials tend to be more wear resistant. Indeed, it is now generally understood that this tends to be the case—FIG. 3 depicts a plot that conveys the general understanding that a material's susceptibility to wear loss is inversely correlated with its hardness. Moreover, as certain classes of materials tend to be correlated with certain levels of hardness, some generalizations can be made as to which materials tend to be resistant to wear. For example, ceramics tend to be harder than bulk metallic glass-based materials (the term ‘bulk metallic glass-based materials is meant to refer to bulk metallic glasses [BMGs] as well as bulk metallic glass matrix composites [BMGMCs], see e.g., U.S. patent application Ser. No. 13/942,932, the disclosure of which is incorporated by reference herein), which themselves tend to be harder than metals. Accordingly, generally speaking, ceramics tend to be more resistant to wear than bulk metallic glass-based materials (BMG-based materials), which themselves tend to be more resistant to wear than metals. FIG. 4 illustrates an Ashby plot that conveys this general understanding.

Note that although bulk metallic glass-based materials generally are not as resistant against wear as ceramics, they have generated interest as viable wear-resistant engineering materials, since they possess a number of other useful materials properties. For example, they are generally tougher than ceramic materials, can be made to be electrically conductive, and can be relatively corrosion resistant. Moreover, their manufacture and processing is conducive to a casting process that can allow a desired component to be directly fabricated by casting the respective material into the desired shape. The ability to cast a material into a desired net shape can substantially enhance manufacturing efficiencies. Accordingly, efforts have been made to develop BMG-based materials so as to improve their resistance to wear. For example, U.S. patent application Ser. No. 13/928,109, entitled “Systems and Methods for Implementing Bulk Metallic Glass-based Macroscale Gears”, by Doug Hofmann et al. discusses implementing bulk metallic glass-based materials in the context of gears. The patent application explains the development of viable wear-resistant bulk metallic glass-based materials that can be implemented in gears. Notably, the application explains that hardness is not the only consideration when determining which material should be used to form a wear-resistant gear. For example, the fracture toughness should also be sufficiently developed in order for the alloy to be truly viable as an engineering material. The disclosure of U.S. patent application Ser. No. 13/928,109 is incorporated by reference herein.

Against this background, it is now observed that certain copper-based alloys have substantially enhanced wear resistance characteristics. Specifically, materials that are based on copper in addition to a group IV metal, where the atomic ratio of copper to the group IV metal is between approximately 2:3 and 3:2, demonstrate particularly superior wear performance. Moreover, materials that are based on this base composition can be alloyed so that other mechanical properties can be tailored without substantially altering the superior wear performance. For example, a desired value for a shear modulus can be achieved by suitably alloying the base material. In some instances, a desired hardness value is achieved via alloying. Note that this contravenes the general understanding of wear performance, i.e., for this class of materials, the wear performance is not significantly correlated with hardness. Thus, for example, the hardness can be established independently from the desire to establish a robust resistance to wear. Hence, this class of materials can serve as the foundation for elite and versatile engineering materials that can be used to develop a variety of high quality engineering components.

Gears, for example, are particularly well-suited to take advantage of materials with improved wear resistance properties. Gears are pervasive engineering components that are commonly used in a variety of actuation mechanisms. For example, gears are typically used to drive automobiles, bicycles, extraterrestrial vehicles, and even watches. Notably, their operation generally hinges on a constant mechanical interaction with a mated component, and gears are thereby prone to wear. Accordingly, it is desirable that gears be formed from robust engineering materials that demonstrate superior wear performance. Thus, in many embodiments, a wear-resistant gear includes a gear body defined by a rotatable body having teeth disposed on an outer surface of the rotatable body, where the gear body is formed at least in part from a material including copper and X, where X is one of zirconium, titanium, hafnium, rutherfordium, and mixtures thereof, and where the atomic ratio of copper to X is approximately between 2:3 and 3:2.

The development of suitable copper-based alloys that have superior wear-resistant properties is now discussed below.

The Development of Copper-Based Alloys that are Characterized by Superior Resistance to Wear

In many embodiments of the invention, a copper-group IV metal alloy is achieved that is characterized by a superior resistance to wear. In many embodiments, a copper-group IV metal material is implemented as a base material in components where resistance to wear is desirable. Any group IV metal may suffice, including zirconium, titanium, hafnium, and rutherfordium. In many embodiments, the ratio of copper to the group IV metal is between approximately 2:3 and 3:2; it has been observed that within this range of atomic ratios, the material is particularly resistant to wear. However, it is preferred if the ratio is closer to 1:1, for example if it is between approximately 9:11 and 11:9. Thus, in many embodiments, the atomic ratio of copper to the group IV metal is between approximately 9:11 and 11:9. Of course additive elements, can be implemented within the base material to manipulate the material properties.

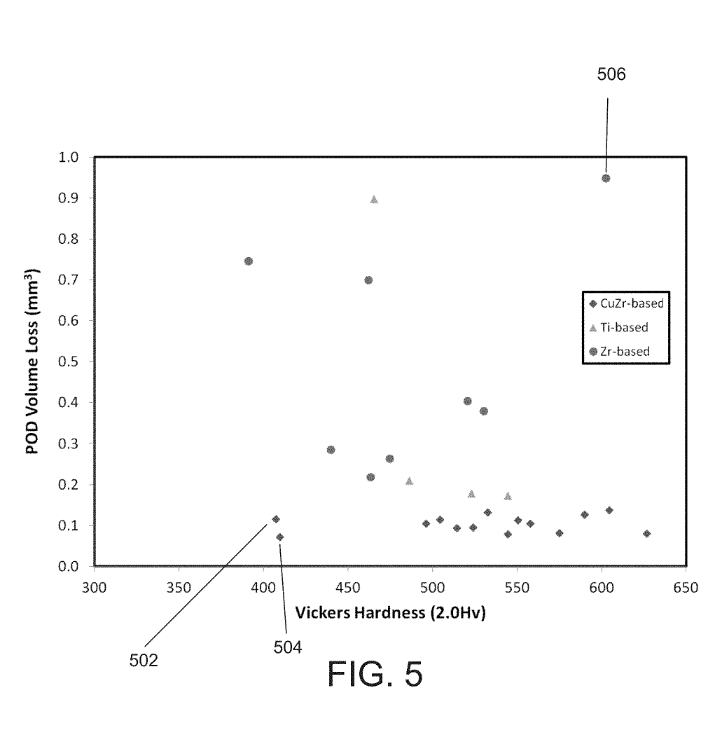

By way of example, a variety of copper-zirconium based alloys were studied with respect to their resistance to wear. Pin-on-disk tests were used to characterize the wear performance of a variety of copper-zirconium based alloys relative to titanium BMG-based alloys and zirconium BMG-based alloys. The wear loss of the respective alloys was measured against the hardness. FIG. 5 depicts a plot of the data obtained. The alloys tested were all bulk metallic glasses, except that two of the tested copper-zirconium alloys, 502 and 504, were crystalline. Note that the copper-zirconium based alloys show superior wear performance relative to the titanium BMG-based alloys and the zirconium BMG-based alloys. Moreover, whereas the wear performance of titanium BMG-based alloys and zirconium BMG-based alloys appears to be correlated with hardness (data point 506 is considered to be an outlier), the wear performance of copper-zirconium based alloys demonstrates independence from hardness. Thus, in many embodiments, a particular copper-zirconium based alloy with superior resistance to wear is selected for implementation within an engineering component. In a number of embodiments a copper-zirconium based material is developed (e.g., via alloying or processing) so that it has the desired hardness while still maintaining superior wear performance characteristics.

Tabulated Data pertaining to wear performance appears below in Table 1.

TABLE 1
Wear Loss Performance of Cu—Zr based Alloys

| | | | | | | VOLUME | |
|---|---|---|---|---|---|---|---|
| | DENSITY | | | | POISSON | LOSS | |
| ALLOY | (g/cm³) | E (GPa) | K (GPa) | G (GPa) | RATIO | (100 × mm³) | PHASE |
| Cu₄₃Zr₄₃Al₇Be₇ | 6.811 | 99.0 | 111.3 | 36.6 | 0.35 | 11.3 | BMG |
| Cu₄₀Zr₄₀Al₁₀Be₁₀ | 6.582 | 114.2 | 117.0 | 42.7 | 0.34 | 13.7 | BMG |
| Cu_{39.77}Zr_{40.74}Al_{6.79}Be_{9.7}Nb₃ | 6.948 | 108.5 | 119.5 | 40.2 | 0.35 | 7.9 | BMG |
| Cu_{45.6}Zr_{44.6}Al_{4.9}Y_{1.9}Nb₃ | 6.925 | 76.9 | 110.7 | 27.8 | 0.38 | 11.6 | BMG |
| Cu_{42.7}Zr_{42.7}Al_{6.8}Be_{4.9}Nb₃ | 7.020 | 97.8 | 118.5 | 35.9 | 0.36 | 7.8 | BMG |
| Cu_{41.7}Zr_{41.7}Al_{6.8}Be_{6.8}Nb₃ | 6.867 | 102.0 | 115.2 | 37.7 | 0.35 | 9.5 | BMG |
| Cu₄₀Zr₄₀Al₁₀Be₁₀ | 6.582 | 114.2 | 117.0 | 42.7 | 0.34 | 13.7 | BMG |
| Cu₄₁Zr₄₀Al₇Be₇Co₅ | 6.864 | 103.5 | 116.8 | 38.3 | 0.35 | 12.6 | Composite |
| Cu₄₂Zr₄₁Al₇Be₇Co₃ | 6.846 | 101.3 | 117.8 | 37.3 | 0.36 | 13.1 | BMG |
| CU_{47.5}Zr₄₈Al₄Co_{0.5} | 7.138 | 79.6 | 116.3 | 28.7 | 0.39 | 10.5 | Crystalline |
| Cu₄₇Zr₄₆Al₅Y₂ | 7.003 | 75.3 | 115.9 | 27.1 | 0.39 | 7.1 | BMG |
| Cu₅₀Zr₅₀ | 7.313 | 81.3 | 116.8 | 29.4 | 0.38 | 9.6 | Crystalline |
| Cu₄₂Zr₄₁Al₇Be₇Cr₃ | 6.813 | 106.5 | 116.1 | 39.5 | 0.35 | 8.1 | BMG |
| Cu₄₄Zr₄₄Al₅Ni₃Be₄ | 7.014 | 95.5 | 115.7 | 35.1 | 0.36 | 11.4 | BMG |
| Cu_{46.5}Zr_{46.5}Al₇ | 7.007 | 101.4 | 113.0 | 37.5 | 0.35 | 10.7 | Crystalline |
| Cu₄₃Zr₄₃Al₇Ag₇ | 7.224 | 90.6 | 117.6 | 33.0 | 0.37 | 10.4 | BMG |
| Cu_{41.5}Zr_{41.5}Al₇Be₁₀ | 6.722 | 104.5 | 113.9 | 38.8 | 0.35 | 10.4 | BMG |
| Cu₄₄Zr₄₄Al₇Be₅ | 6.978 | 99.0 | 114.0 | 36.5 | 0.36 | 9.3 | BMG |
| Cu₄₃Zr₄₃Al₇Be₇ | 6.811 | 99.0 | 111.3 | 36.6 | 0.35 | 11.3 | BMG |
| Cu₄₄Zr₄₄Al₇Ni₅ | 7.052 | 99.2 | 114.8 | 36.6 | 0.36 | 9.2 | Composite |
| Ti_{33.18}Zr_{30.51}Ni_{5.33}Be_{22.88}Cu_{8.1} | 5.481 | 96.9 | 110.6 | 35.8 | 0.35 | 21.0 | BMG |
| Ti₄₀Zr₂₅Be₃₀Cr₅ | 4.850 | 97.5 | 104.6 | 36.2 | 0.34 | 89.7 | BMG |
| Ti₄₀Zr₂₅Ni₈Cu₉Be₁₈ | 5.501 | 101.1 | 110.8 | 37.5 | 0.35 | 17.3 | BMG |
| Ti₄₅Zr₁₆Ni₉Cu₁₀Be₂₀ | 5.322 | 104.2 | 111.1 | 38.8 | 0.34 | 17.9 | BMG |
| Vitreloy 1 (ZrTiCuNiBe) | 6.061 | 95.2 | 109.6 | 35.1 | 0.36 | 37.9 | BMG |
| Vitreloy 105 (ZrTiCuNiAl) | 6.670 | 88.5 | 110.5 | 32.4 | 0.37 | 26.2 | BMG |
| Vitreloy 106 (ZrNbCuNiAl) | 6.667 | 83.3 | 111.5 | 30.3 | 0.38 | 28.5 | BMG |
| Zr₅₅Cu₃₀Al₁₀Ni₅ | 6.690 | 87.2 | 110.3 | 31.9 | 0.37 | 40.4 | BMG |
| Zr₆₅Cu_{17.5}Al_{7.5}Ni₁₀ | 6.643 | 116.9 | 110.5 | 44.2 | 0.32 | 21.8 | BMG |
| DH1 (ZrTiNbCuBe) | 5.700 | 84.7 | 105.8 | 31.0 | 0.37 | 74.6 | Composite |
| Zr₃₅Ti₃₀Cu_{8.2}Be_{26.8} | 5.361 | 90.5 | 104.4 | 33.4 | 0.36 | 69.9 | BMG |

Note that the wear performance was uniformly excellent for the copper-zirconium based alloys, even where the young's modulus, shear modulus, and bulk modulus were made to vary. Thus, in many embodiments of the invention, an engineering component where resistance to wear is desirable is formed from one of the above-identified copper-zirconium based materials.

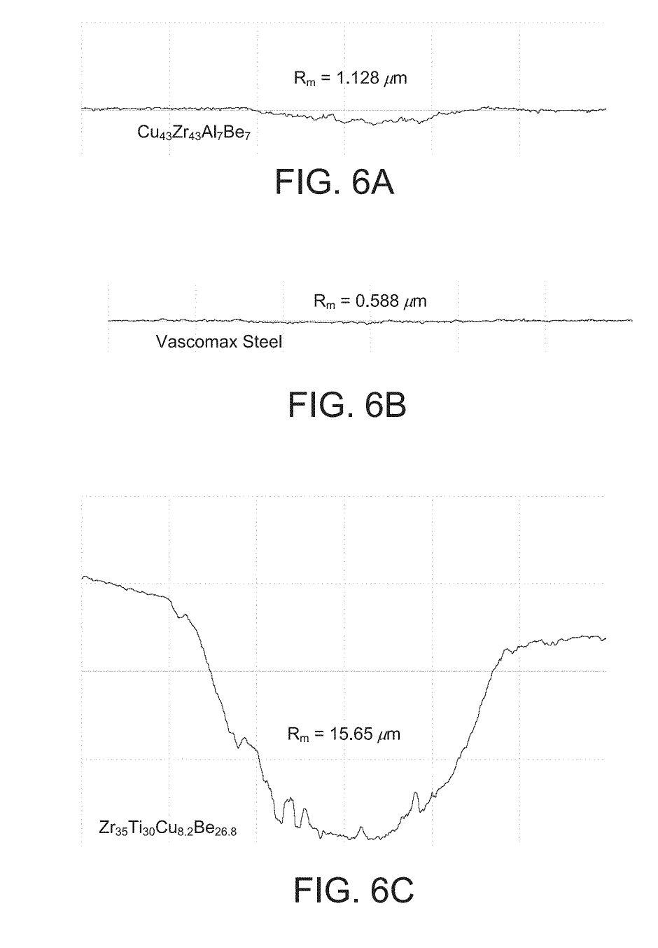

FIGS. 6A-6C illustrate the profilometry of a selected copper-zirconium BMG-Cu₄₃Zr₄₃Al₇Be₇—relative to that of a Vascomax Steel, and a zirconium based BMG-Zr₃₅Ti₃₀Cu_{8.2}Be_{26.8}, after they endured the above mentioned pin-on-disk test, and highlights the improved wear performance that copper-based materials can offer. In the illustration Rₘ refers to the distance between the top of the surface and the peak depth of the material, and is thereby indicative of how much the material has worn away. Note that the copper-zirconium alloy has an Rₘ that is similar to that of Vascomax steel. Although the figures suggest that the particular Vascomax steel has superior wear resistance properties relative to the illustrated copper-zirconium alloy, the copper-zirconium based alloy can be developed to be advantageous in other respects. For example, a copper-zirconium alloy can be developed to have an amorphous structure if that is desired. Additionally, a copper-zirconium based alloy can be cast into a desired shape, which again, is extremely beneficial from a manufacturing perspective.

Additionally, it should be noted that when copper-zirconium bulk metallic glass alloys were assessed via gear-on-gear testing (discussed in greater detail below), they substantially outperformed their Vascomax counterparts. In particular, the copper-zirconium bulk metallic glass alloys demonstrated 3 times lower volume loss, notwithstanding the fact that corresponding pin-on-disk tests suggest that the difference in wear performance between the two materials is negligible.

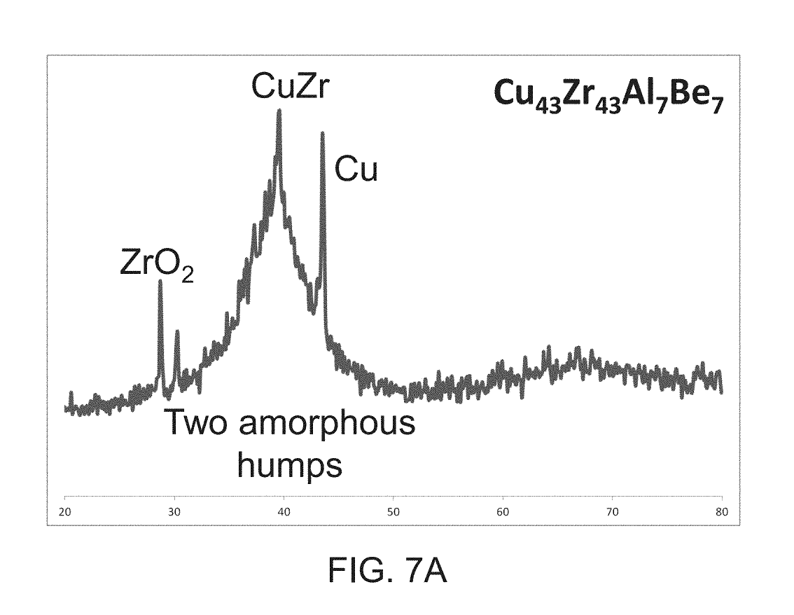

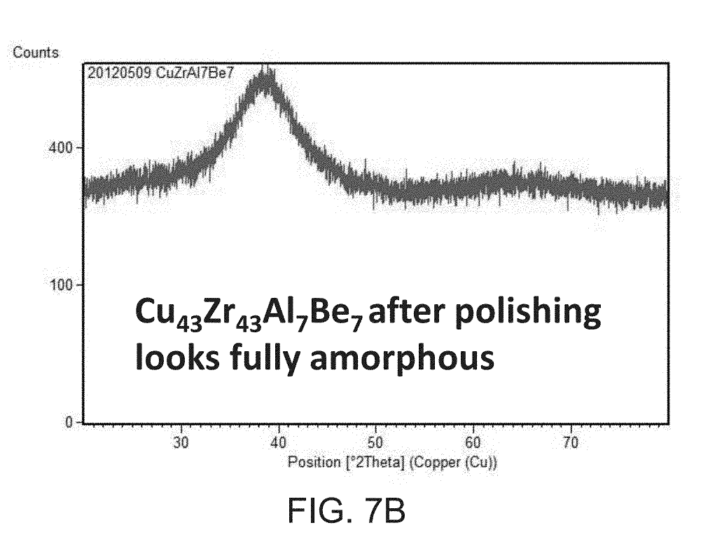

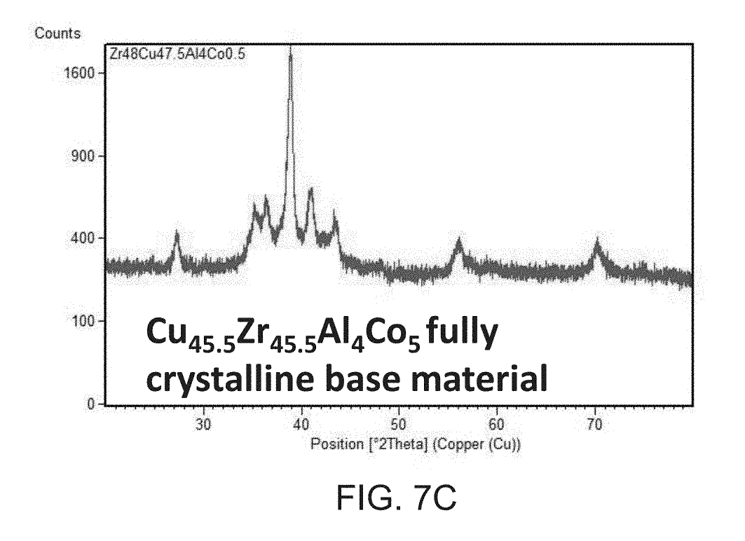

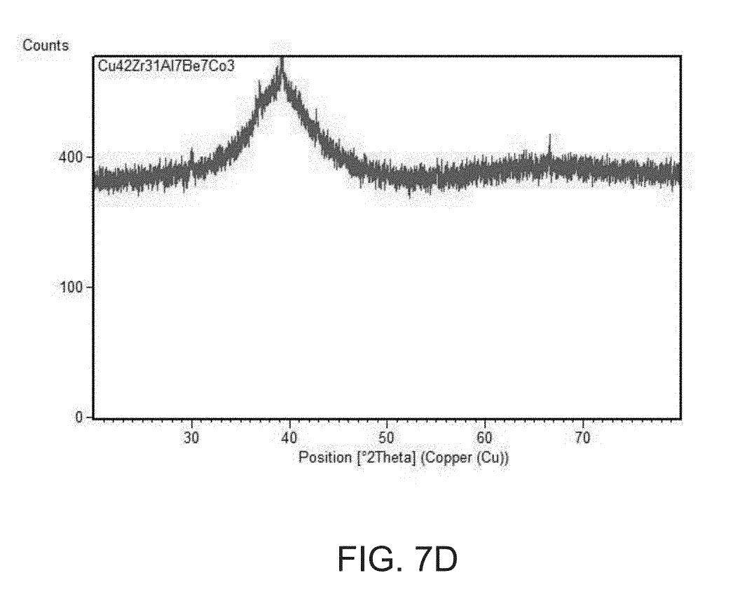

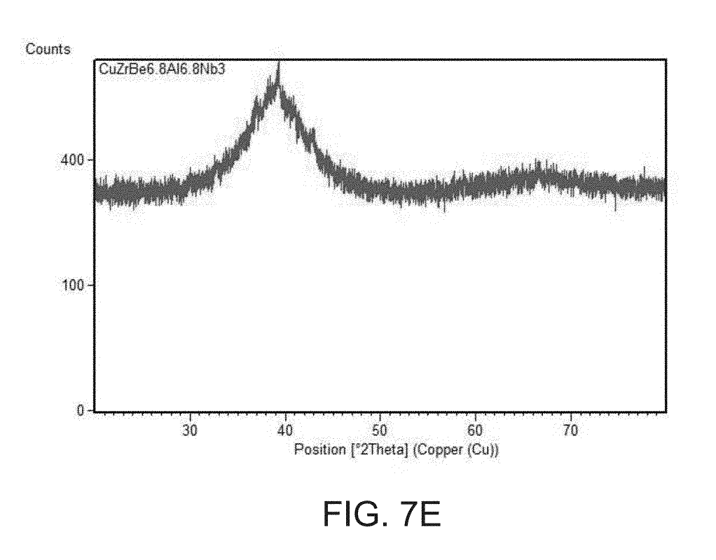

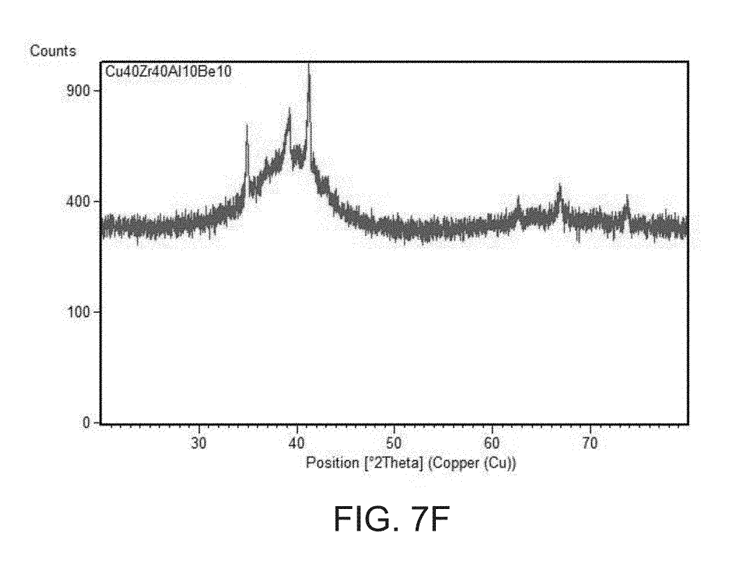

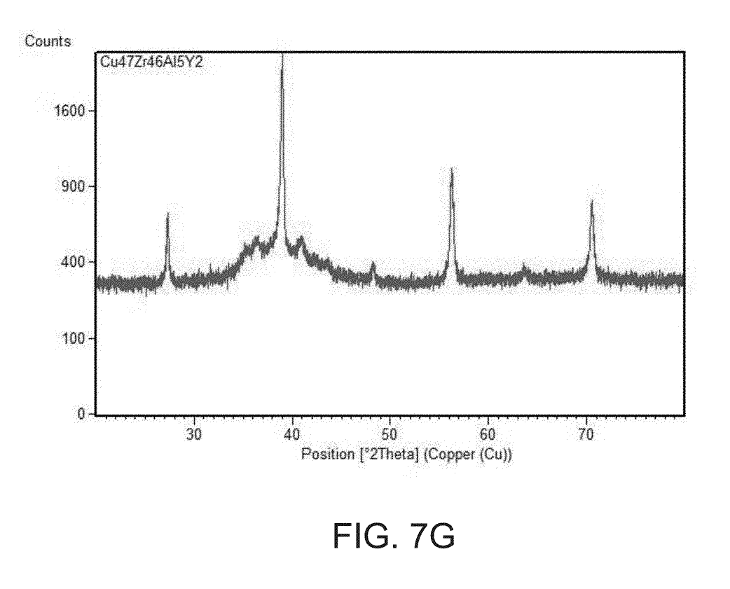

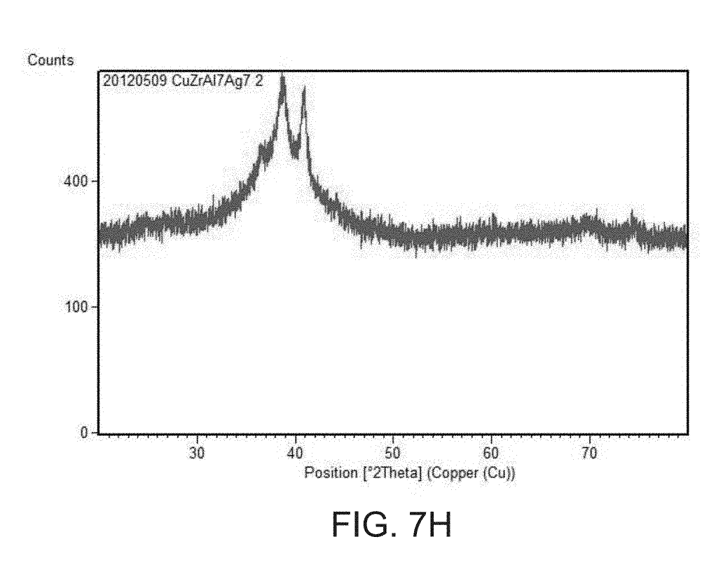

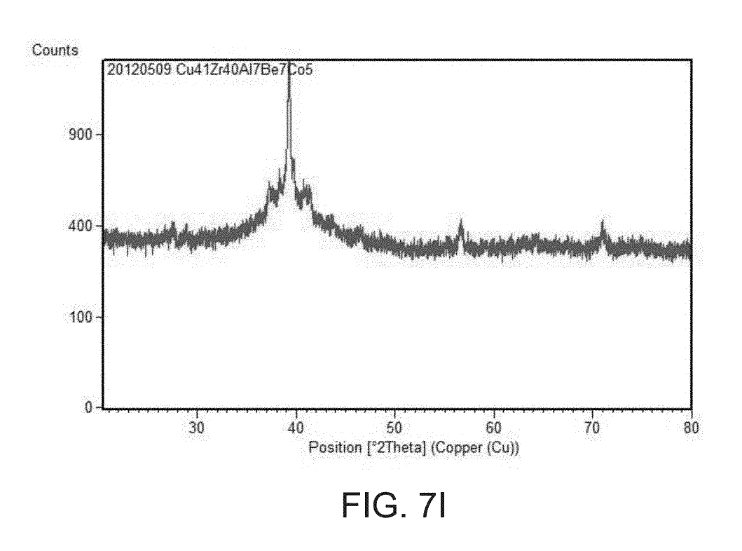

X-ray diffraction (XRD) was used to analyze several copper-zirconium alloys to determine whether wear performance was a function of the presence of particular phases within the alloy. FIGS. 7A-71 depict the results of the XRD studies. In particular: FIG. 7A depicts the XRD results for a Cu₄₃Zr₄₃Al₇Be₇ bulk metallic glass; FIG. 7B depicts the XRD results for a polished Cu₄₃Zr₄₃Al₇Be₇ bulk metallic glass; FIG. 7C depicts the results for a Zr₄₈Cu_{47.5}Al₄Co_{0.5} fully crystalline bulk material; FIG. 7D depicts the results for a Cu₄₂Zr₃₁Al₇Be₇C₃ material; FIG. 7E depicts the results for a Cu_{41.7}Zr_{41.7}Be_{6.8}Al_{6.8}Nb₃ material; FIG. 7F depicts the results for a Cu₄₀Zr₄₀Al₁₀Be₁₀ material; FIG. 7G depicts the results for a Cu₄₇Zr₄₆Al₅Y₂ material; FIG. 7H depicts the results for a Cu₄₃Zr₄₃Al₇Ag₇; and FIG. 7I depicts the results for a Cu₄₁Zr₄₀Al₇Be₇Co₅ material. Importantly, these materials all displayed substantially similar wear performance, notwithstanding the fact that they all included different crystalline phases, e.g., they were crystalline, fully amorphous, composites, and/or nanocrystalline. With respect to FIGS. 7A and 7B, the fact that polishing the alloy results in an XRD scan that indicates that the alloy is fully amorphous, suggests that the crystalline phases seen in FIG. 7A were present in a surface layer. In essence, it is seen that the wear performance of the copper-zirconium alloys is invariant to the crystalline structure of the underlying bulk material. In many embodiments, any of the above referenced copper-zirconium alloys is implemented in components where resistance to wear is desired.

Note that although the data presented thus far has regarded copper-zirconium alloys, the scope of the disclosure is not so limited. For instance, it has been confirmed that copper-titanium alloys also display enhanced wear performance. This accords with conventional understanding as titanium and zirconium fall within the same group in the periodic of elements, and it is understood that elements within the same group tend to exhibit similar chemical properties. Accordingly, copper-hafnium alloys and copper-rutherfordium alloys may also exhibit enhanced wear performance if the alloys are developed such that the atomic ratio of copper to the group-IV metal is between approximately 2:3 and 3:2. Thus, in many embodiments, a copper-hafnium alloy where the atomic ratio of copper to hafnium is between approximately 2:3 and 3:2 is implemented in components where resistance to wear is desired. Similarly, in a number of embodiments, a copper-rutherfordium alloy where the atomic ratio of copper to hafnium is between approximately 2:3 and 3:2 is implemented where resistance to wear is desired.

In any case, as it has been demonstrated that the wear performance of copper-zirconium alloys can be maintained irrespective of the presence or absence of particular crystalline phase structures, in many embodiments, copper-group IV materials are alloyed so as to manipulate mechanical properties while preserving the superior wear performance characteristics to make them well-suited for particular applications. Thus, in some embodiments, a copper-group IV metal base material is selected, and the composition of further constituent elements is varied based on other desired mechanical traits.

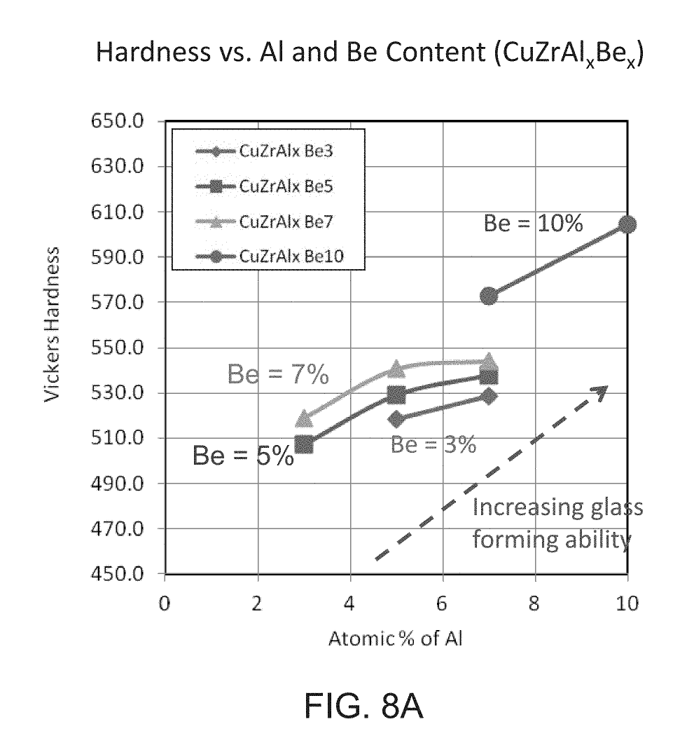

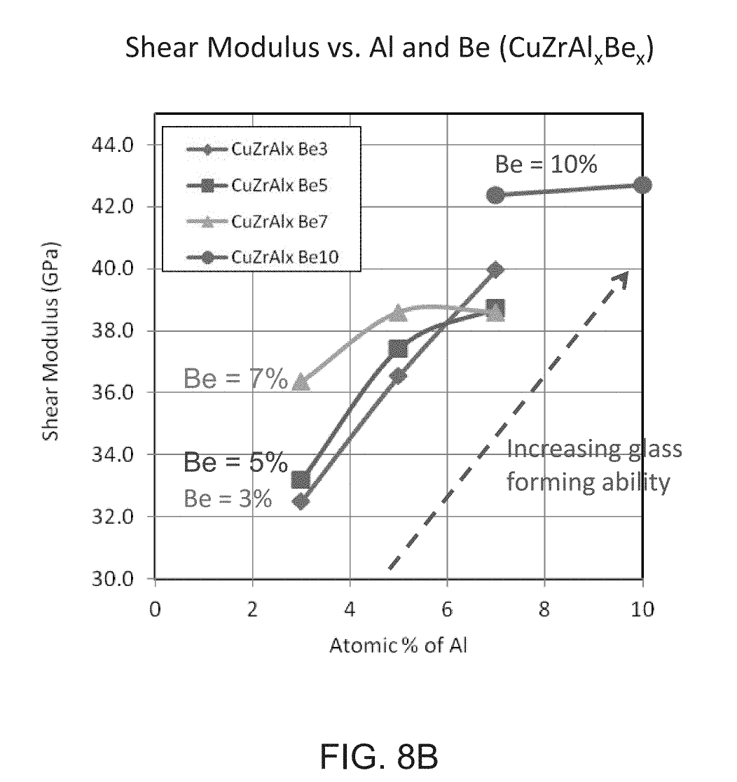

FIGS. 8A and 8B depict how mechanical traits of a Cu_{(100-x-y)/2}Zr_{(100-x-y)/2}AlₓBe_{y} alloy can be varied by modulating the composition of the other constituent components. In particular, FIG. 8A depicts how the hardness of the alloy can be increased by increasing the atomic % of aluminum. In the illustration, the subscripts for copper and zirconium are omitted for brevity—the subscripts for the aluminum and beryllium are relative to 100, and the copper and zirconium have a 1:1 ratio; thus, CuZrAl₃Be₃ is shorthand for Cu₄₇Zr₄₇Al₃Be₃. Note that increasing the atomic % of aluminum, also increases the glass forming ability of the alloy. Generally, glass formability is inversely correlated with toughness (and toughness is generally inversely correlated with hardness). Similarly, FIG. 8B illustrates how the shear modulus can be controlled by varying the atomic % of aluminum. Again, the shear modulus is generally increased by increasing the atomic % of aluminum. Importantly, the wear performance is largely the same for all of the variants of the alloy. Thus, hardness, toughness, glass forming ability, and shear modulus can be established as design parameters independently from a desire to achieve a material with superior wear performance in accordance with embodiments of the invention. Again, although copper-zirconium alloys are discussed, the same principles may be applied to other copper-group IV metal alloys in accordance with embodiments of the invention. Accordingly, in many embodiments, a copper-group IV metal alloy where the atomic ratio of copper to the group IV metal alloy is between approximately 2:3 and 3:2 is developed for a particular application by alloying the base alloy to achieve the desired traits, e.g., hardness and/or shear modulus.

Of course, any alloying elements can be used to manipulate materials properties in accordance with embodiments of the invention. For example, Be, Ti, Cr, Fe, Co, Ni, Zn, Al, B, C, Si, P, Y, b, Mo, Pd, Ag, Sn, Sb, Hf, Ta, W, Pt, and/or Au may be added to the base copper-group IV metal material to achieve a material with desired properties in accordance with embodiments of the invention.

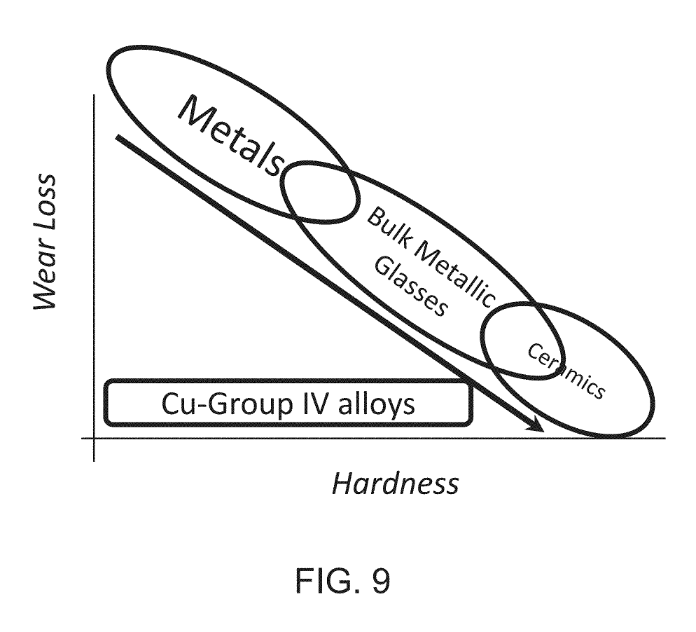

Against this background, FIG. 9 depicts an Ashby plot that illustrates a new paradigm for the understanding of wear resistant materials. In particular, it is illustrated that copper-group IV metal materials can have superior wear performance at varying hardness levels.

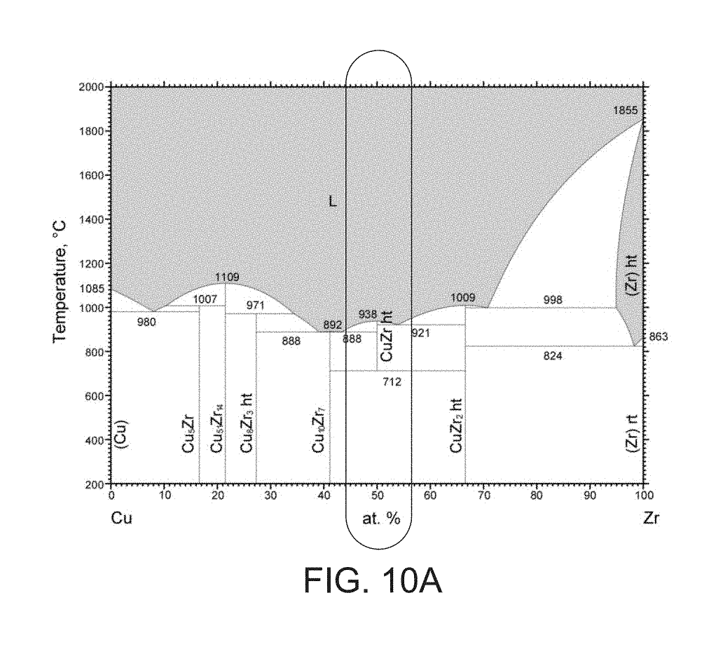

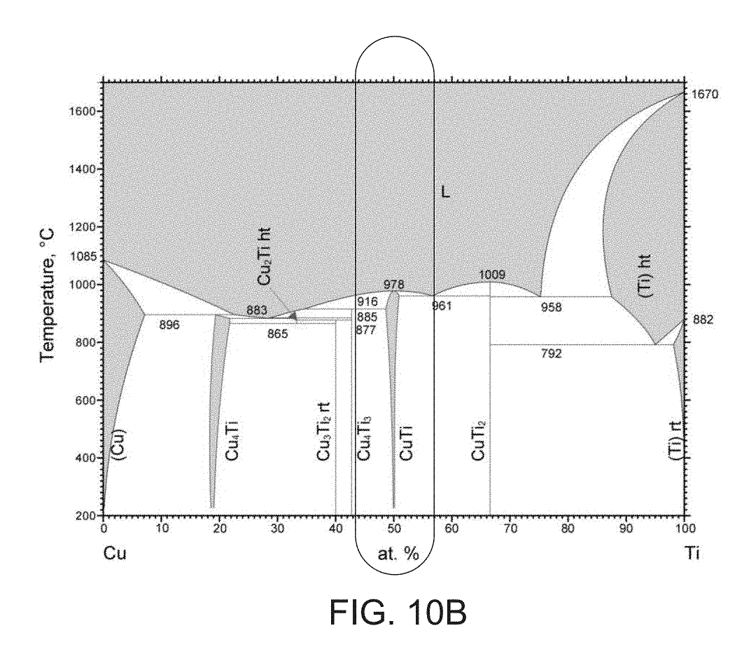

For context, FIGS. 10A and 10B depict phase diagrams of copper-zirconium and copper-titanium alloys respectively. As FIG. 10A illustrates, a copper-zirconium alloy at a ratio of 1:1 has a melting temperature of approximately 938° C. Note that zirconium itself has a melting temperature of 1855° C., and thus, alloying zirconium with copper can significantly reduce the melting temperature, e.g., by almost half. This substantial reduction in melting temperature is advantageous and can allow the material to be net cast into a desired shape. When CuZr alloys crystallize, they can form CuZr intermetallics (i.e., a B₂ shape memory alloy), Cu₁₀Zr₇ and CuZr₂ and can also form a ZrO₂ oxide on its surface.

The copper-titanium phase diagram illustrated in FIG. 10B is similar to the copper-zirconium diagram seen in FIG. 10A except that the melting temperature where the ratio of Copper to Titanium is about 1:1 is 978° C. Note that the melting temperature of Titanium is 1670° C. Thus, alloying titanium with copper does not yield as great a reduction in melting temperature as alloying zirconium with copper. Accordingly, copper-titanium alloys are not as good glass formers as copper-zirconium alloys. Note that when CuTi alloys crystallize, they can form CuTi, Cu₄Ti₃, and CuTi₂ (two intermetallics) and TiO₂ on the surface.

The believed reason for the improved wear performance is now discussed below.

### Wear Mechanics

After much experimentation and testing, it is now believed that the reason for the improved wear resistant properties lies in the development of a slow-forming tarnish oxide layer that serves to protect the underlying bulk material. In particular, it was noted that gradually over time, a copper-zirconium BMG-based disk would discolor. Conversely, a zirconium BMG-based disk would not discolor. Instead, the zirconium BMG-based disk would rapidly form a passive oxide layer. It is now understood that when such a disk is subjected to a wear-causing process, the passive oxide layer is worn away, but quickly reforms. The wear-causing process can continue to wear away the quickly re-forming passive oxide layer, thereby wearing away the bulk material. Conversely, the gradual discoloration of the copper-zirconium disk suggests the formation of a slow-forming thin tarnish layer. Accordingly, when such a disk is subjected to a wear-causing process, the tarnish layer quickly wears away thereby exposing the underlying bulk material. The underlying copper-zirconium bulk material is inherently extremely wear resistant; thus with the slow-forming tarnish layer worn away, the wear causing process directly interacts with the robust underlying bulk material, which is resilient against the mechanical interaction.

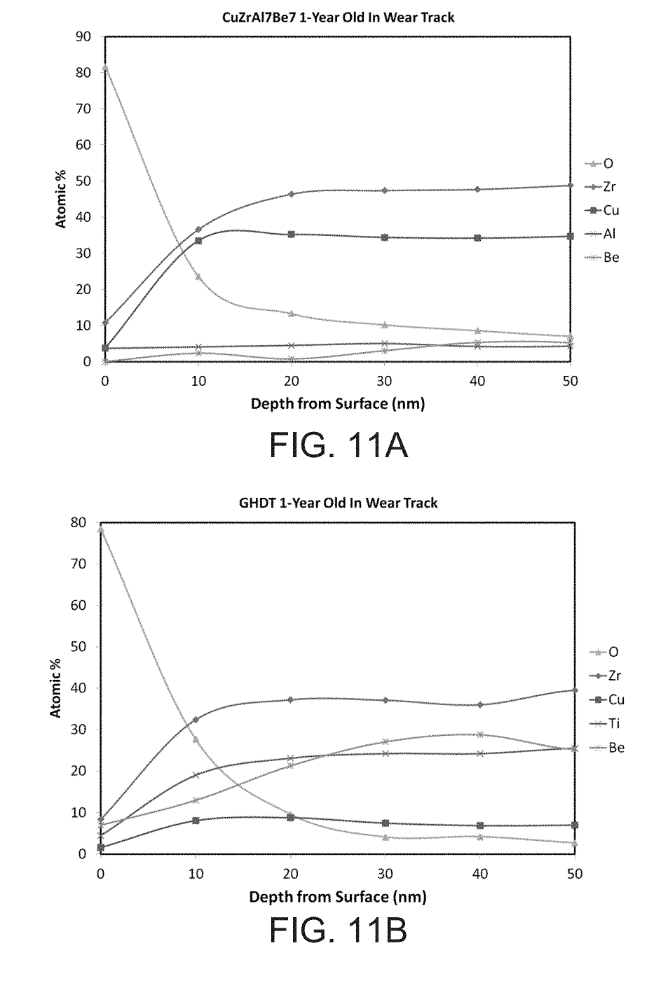

XPS studies were conducted to verify the composition of the copper-zirconium alloy relative to a standard zirconium BMG-based material. The results are depicted in FIGS. 11A and 11B. In particular, FIG. 11A depicts the oxide layer for a copper-zirconium alloy, whereas FIG. 11B depicts the oxide layer for a zirconium-based BMG. Both disks have oxide layers that are roughly less than 30 nm.

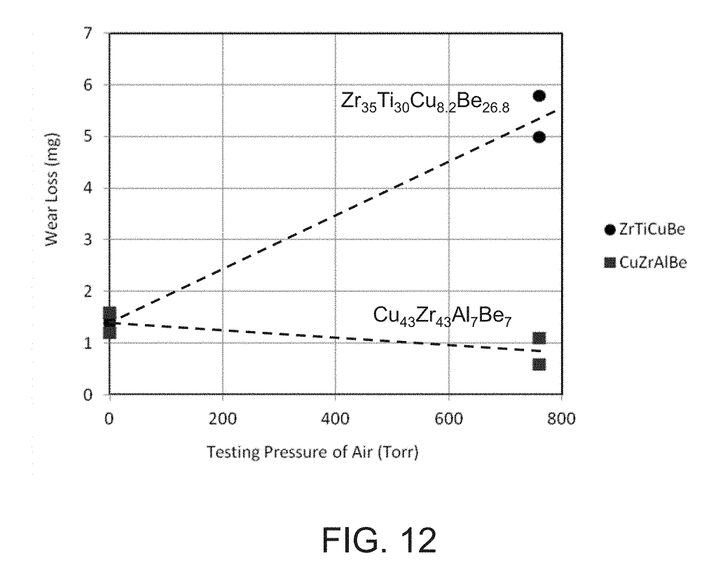

The proposed understanding of the wear mechanics was tested by subjecting both a copper-zirconium BMG-based material and a zirconium BMG-based material to a wear causing process in ambient pressure and in a substantial vacuum, with the understanding that no oxide layers would be able to form in the vacuum. The results are illustrated in FIG. 12. Note that the data shows that, as the pressure is reduced from ambient to 10⁻³ torr (i.e., near zero), the zirconium-based bulk metallic glass and the copper-based bulk metallic glass converge to similar wear performance. The reduction in pressure hinders the ability for an oxide layer to develop. Where the oxide layer is removed, both materials are exposed and display similar wear performance under the exposed condition. Accordingly, the results suggest that the presence of an oxide layer greatly impacts the wear performance of various materials.

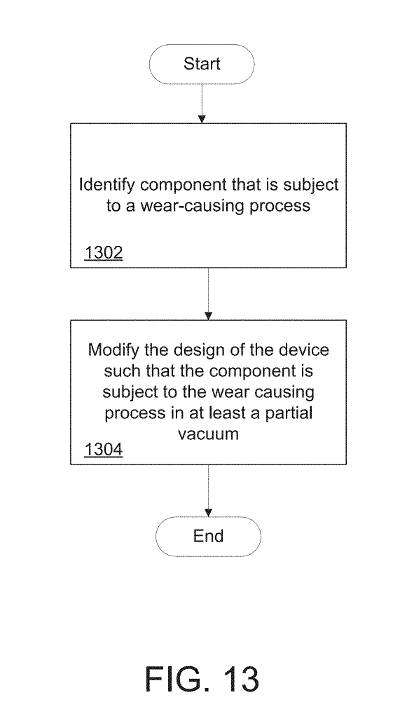

Thus, in many embodiments of the invention, devices that rely on constituent components that are subject to a wear-causing process during the operation of the device, are modified such that those constituent components operate in at least a partial vacuum when subjected to a wear-causing process. A method of improving a device that includes components that are subject to wear-causing processes is illustrated in FIG. 13. In particular, the method includes identifying (1302) a component that is subject to a wear-causing process in the device, and modifying (1304) the design of the device such that the component is subject to the wear-causing process in at least a partial vacuum. As demonstrated above, in many instances, wear is a surface phenomenon, i.e., the surface chemistry seemingly impacts wear performance. Accordingly, limiting the formation of harmful oxides that may cause the gradual degradation of the material, by having the wear-causing process occur in at least a partial vacuum, may improve wear performance.

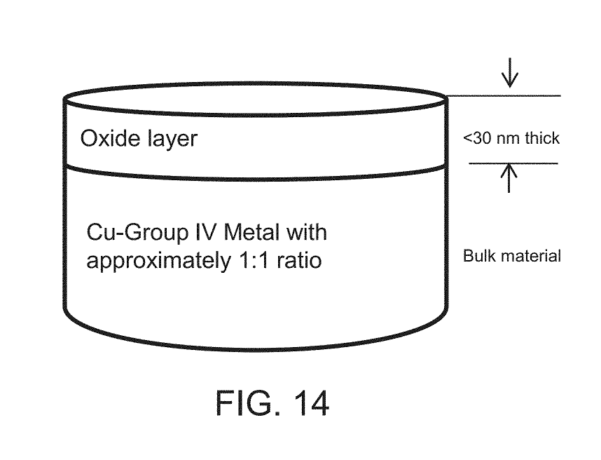

FIG. 14 depicts a generalized schematic of a copper-group IV metal that has superior wear characteristics. In particular, an oxide layer, is illustrated that protects the underlying bulk material. Notably, the crystalline phase of the underlying bulk material is largely irrelevant to wear performance.

Of course, it should be understood that these materials with superior wear resistant characteristics can be implemented in any number of engineering components where resistance to wear is desirable in accordance with embodiments of the invention. For example, these materials can be used to fabricate gears, ball or roller bearings, bearing race, axle, shaft, or any other component of a gearbox or bearing. Thus, in many embodiments, at least those portions of an engineering component that are subject to wear are fabricated from the above-discussed wear-resistant materials. As an example, the development of gears that are fabricated from these materials is now discussed below.

### Gears Having Superior Resistance to Wear

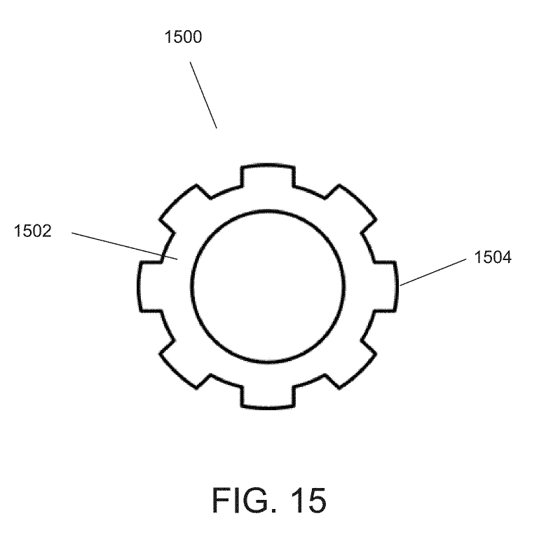

In many embodiments, a gear having superior resistance to wear is fabricated from a copper-group IV alloy where the atomic ratio of the copper to the group IV alloy is between approximately 2:3 and 3:2. In more preferable embodiments, the atomic ratio is closer to 1:1. As one of ordinary skill in the art would understand, a gear is a machine that can be used to transmit force. A gear typically includes a rotatable body having teeth on an outer surface. The teeth allow the gear to engage with a mated component. FIG. 15 illustrates a gear. In particular, the gear 1500 includes a rotatable body 1502 and teeth 1504 on the outer surface of the rotatable body. The teeth can allow the gear to engage with a mated component.

Gears can benefit greatly from materials having superior wear performance, as their operation is largely based on the mechanical interaction with a mated component, which can of course cause wear. This mechanical interaction can of course result in wear.

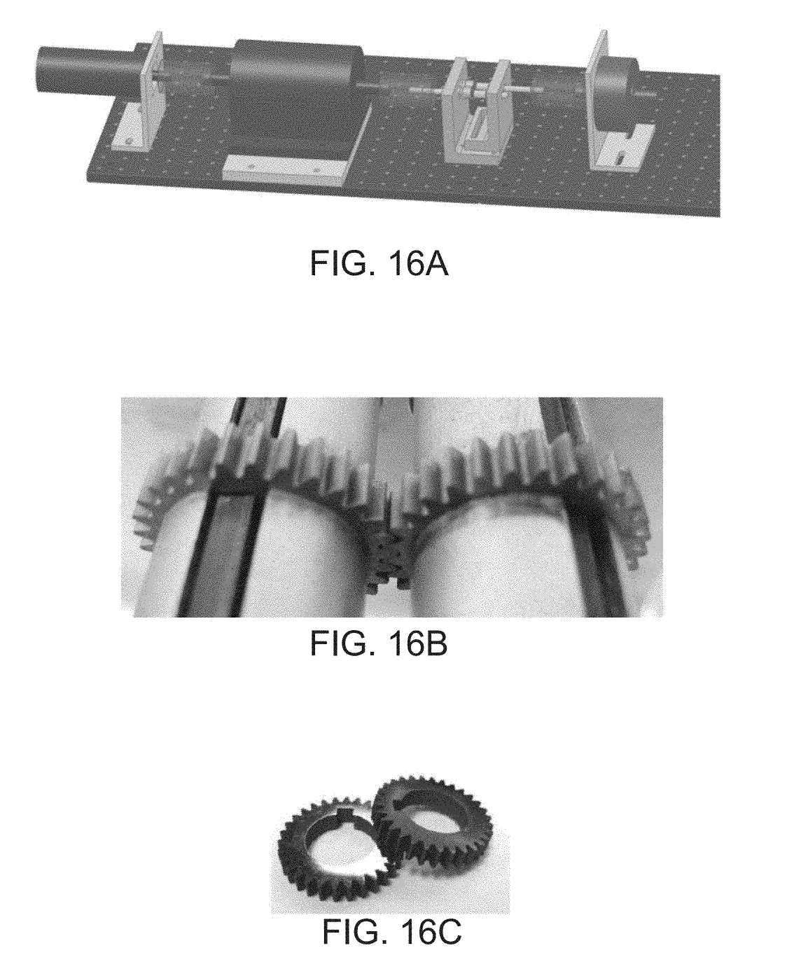

Gears fabricated from copper-group IV metal alloys were tested to confirm their efficacy. FIGS. 16A-16C illustrate the setup used to test the gears. In particular, FIG. 16A is a schematic of the gear testing rig that was used. FIG. 16B is illustrates how gears were engaged with each other for the purposes of testing, and FIG. 16C is a picture of gears that were tested. As can be inferred from FIG. 16B, the gears were tested by having them engage with one another, and having one of them drive the other. This type of testing is referred to as ‘gear-on-gear’ testing. The gears were driven for 3 hours, unless otherwise noted. The gears that were tested were fabricated either machining with an electric discharge machine (EDM) or net shape casting. The results are presented below in Table 2.

TABLE 2
Gear-on-Gear Testing Results

| | Mass loss after 3 hours | | Total Loss |
|---|---|---|---|
| Alloy | Driven gear | Drive gear | (mg) |
| Zr_{36.6}Ti_{31.4}Nb₇Cu_{5.9}Be_{19.1}^{c} | 33.9 | 113.1 | 147.0^{a} |
| Zr₃₅Ti₃₀Cu_{8.2}Be_{26.8} | 50.8 | 100.5 | 151.3 |
| Zr₃₅Ti₃₀Cu_{8.2}Be_{26.8}^{b} | 45.3 | 78.7 | 124.0 |
| Vascomax Steel^{d} | 28.3 | 20 | 48.3 |
| Cu₄₇Zr₄₇Al₃Be₃^{b,d} | 10.0 | 25.7 | 35.7 |
| Cu_{46.5}Zr_{46.5}Al₅Y₂^{c} | 10.4 | 15.9 | 26.3 |
| Cu₄₃Zr₄₃Al₇Be₇^{b} | 6.6 | 15.7 | 22.3 |
| Cu₄₃Zr₄₃Al₇Be₇ | 8.8 | 9.2 | 18.0 |
| Cu₄₄Zr₄₄Al₅Be₇^{b} | 8.6 | 11.4 | 20.0 |

^{a}test stopped after 1.5 hours
^{b}represents a gear that was cast to a net shape
^{c}represents a BMG composite
^{d}represents fully crystalline alloys
*All gears were made through EDM unless noted

Notably, the copper-zirconium alloys uniformly outperformed the Vascomax steel as well as the zirconium BMG-based alloys.

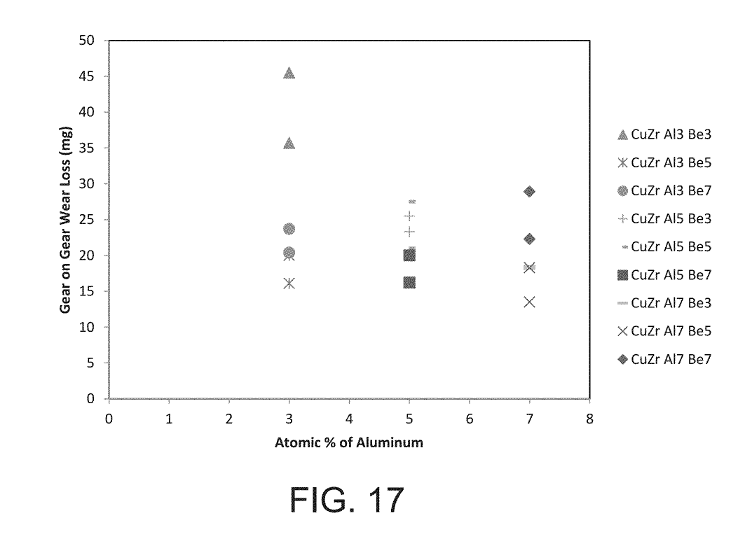

Gear-on-gear tests were also performed for the alloys discussed with respect to FIGS. 8A and 8B. These results are illustrated in FIG. 17. As before, in the illustration, the subscripts for copper and zirconium are omitted for brevity—the subscripts for the aluminum and beryllium are relative to 100, and the copper and zirconium have a 1:1 ratio; thus, CuZrAl₃Be₃ is shorthand for Cu₄₇Zr₄₇Al₃Be₃. Two data points are present for each combination—and the higher of the two reflects the when the test was ran with a 10 in./lb. torque (i.e., a ‘brake’) on the driven gear, while the lower of the two reflects when the test was ran with a 5 in./lb. torque on the driven gear. Additionally, note that the depicted alloys embody a variety of crystalline structures. For example, Cu₄₇Zr₄₇Al₃Be₃ is fully crystalline, Cu₄₆Zr₄₆Al₃Be₅ is partially crystalline, and Cu₄₃Zr₄₃Al₇Be₇ is fully amorphous. This further establishes the above-discussed proposition that the wear performance of the disclosed alloys is invariant to the particular crystalline structure.

Accordingly, in many embodiments the material from which to fabricate the gear from is selected based on the desired mechanical properties of the gear. For example, with respect to CuZrAlBe gears, where a softer gear is desired, a material with a relatively reduced aluminum content may be used to form the gear. For example, Cu₄₆Zr₄₆Al₃Be₅ may be used.

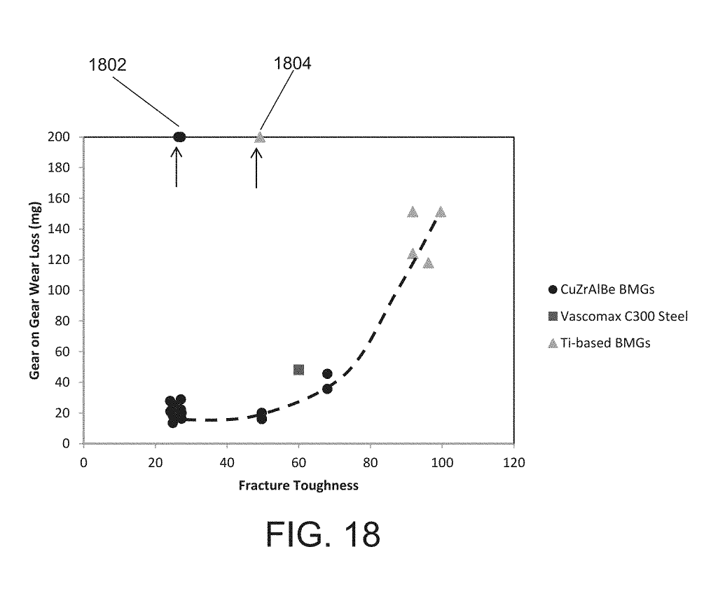

FIG. 18 illustrates wear performance as a function of fracture toughness for the copper-zirconium alloys, Vascomax steel, and titanium-based BMGs. The plot interestingly shows that the copper-zirconium alloys have superior wear performance in spite of their low fracture toughness, which contravenes the previously understood model for wear performance, i.e., conventional understanding generally posits that materials with higher fracture toughnesses will provide greater resistance to wear since they would be sufficiently resistant to brittle failure. For example, data point 1804 indicates that when a zirconium BMG-based material was configured so that it had a relatively lower fracture toughness, it fractured during testing. Note that two data points 1802 indicate that two of the copper-zirconium alloys did fracture. Thus, when selecting a material to fabricate components, it is still important to ensure that the selected material is sufficiently resistant to fracture in view of the desired application.

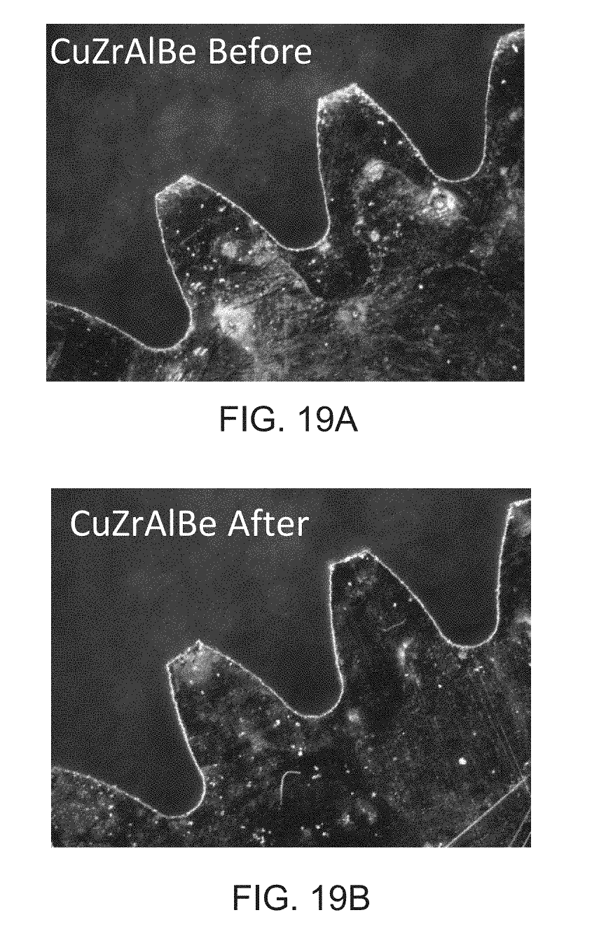

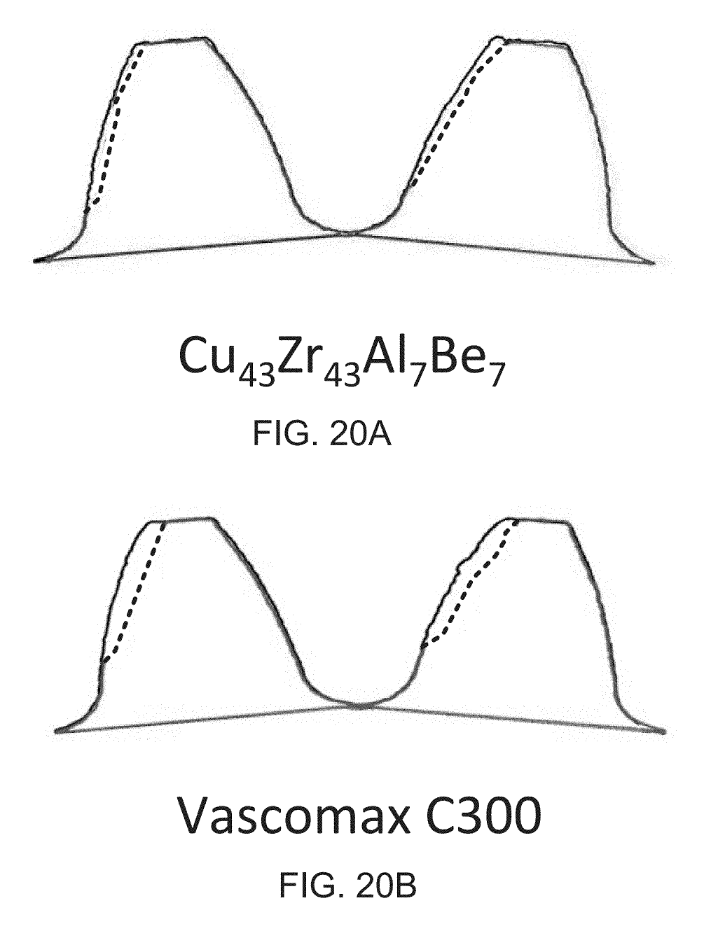

FIGS. 18A and 18B illustrate before and after pictures of a CuZrAlBe alloy before and after being subjected to the three-hour gear-on-gear wear-causing process. The wear is virtually unnoticeable. Similarly, FIGS. 19A-19B depict the profilometry of a the CuZrAlBe alloy relative to a Vascomax C300 Steel after they had each been subject to the same testing. In particular, FIG. 19A depicts the profilometry of the CuZrAlBe alloy, while FIG. 19B depicts the profilometry for the Vascomax C300 steel (the dashed line represents the profile of the surface after the testing). The superior wear performance of the CuZrAlBe alloy is evident.

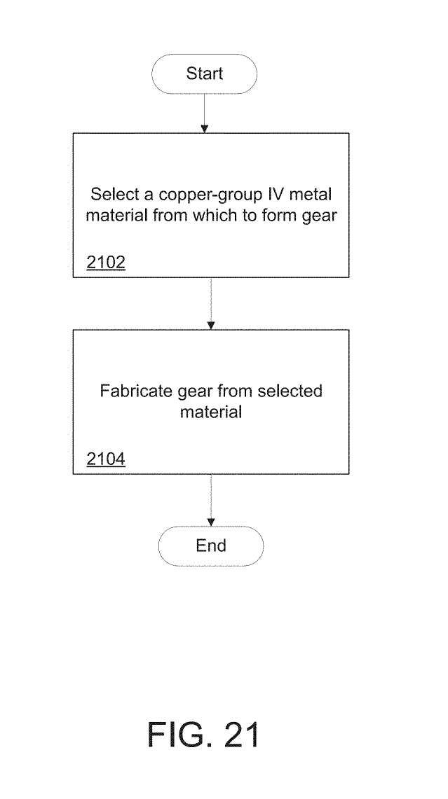

Thus, in many embodiments, a method of fabricating a wear-resistant gear from a copper-group IV metal is provided. A method of fabricating a wear-resistant gear from a copper-group IV metal that includes selecting a copper-group IV metal material from which to form the gear, and fabricating the gear from the selected material is illustrated in FIG. 21. In particular, the method includes selecting (2102) a copper-group IV metal material from which to form the gear, and fabricating (2104) the gear from the selected material. Of course, any of the above-discussed copper-group IV metal alloys can be selected. The atomic ratio of the copper to the group IV metal alloy is generally between approximately 2:3 and 3:2. Although, more preferably, the atomic ratio is between 9:11 and 11:9. As can be inferred, the selected base copper-group IV metal alloy can include further constituent elements including but not limited to: Be, Ti, Cr, Fe, Co, Ni, Zn, Al, B, C, Si, P, Y, b, Mo, Pd, Ag, Sn, Sb, Hf, Ta, W, Pt, and/or Au. Moreover, the material can be selected based on the desired mechanical properties. For example, where a harder material is desired, a CuZrAlBe alloy with a relatively higher concentration of aluminum can be selected.

Of course, it should be understood that many types of gears can benefit from being formed from the wear resistant materials discussed above, not just the spur gears illustrated. For example, in many embodiments, the copper-based wear resistant materials discussed above are used to form helical gears, double helical gears bevel gears, spiral bevel gears, hypoid gears, crown gears, worm gears, non-circular gears, rack and pinion gears, epicyclic gears, sun and planet gears, harmonic drive gears, and cage gears. And more generally, it should be understood, that any copper-group IV based alloy can be implemented in any applications where resistance to wear is desired in accordance with embodiments of the invention; the disclosure is not limited to implementing the alloys in gears. For example they can be implemented as casings for consumer electronics. Moreover, as also already mentioned above, the scope of the disclosure is not limited to copper-zirconium based alloys; any group IV metal may be alloyed with copper to form a base material with superior wear performance in accordance with embodiments of the invention. In general, as can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

1. A method for increasing the wear-resistance of a mechanical component comprising:
forming a mechanical component having at least one outer surface configured to engage with a mated component and subject to a wear-causing process;
wherein at least an outer surface of the mechanical component is formed from a material having a fracture toughness of less than 80 MPa·m^{1/2}, a hardness of less than 450 Vickers and comprising CuZrXZ and optionally Z,
wherein X is at least one of Al and Be,
wherein Z is one of: Y, Nb, Ti, Cr, Fe, Co, Ni, Zn, B, C, Si, P, Mo, Pd, Ag, Sn, Sb, Hf, Ta, W, Pt, Au, and mixtures thereof,
wherein the atomic % of Cu is at least 39.77,
wherein the atomic % of Al, where present, is between approximately 3% and 10%,
wherein the atomic % of Be, where present, is between approximately 3% and 10%, and
wherein the atomic ratio of Cu to Zr is approximately between 2:3 and 3:2;
preparing the mechanical component such that a at least one outer surface has surface irregularities sufficiently small to prevent wear of greater than 15 μm in a single wear cycle; and
configuring the mechanical component such that the wear-causing process from the mated component imparts a wear stress on the at least one outer surface of less than 5 MPa such that oxidation of the outer surface of the component is inhibited during operation of the wear-causing process.

2. The method of claim 1, wherein the atomic ratio of Cu to Zr is approximately between 9:11 and 11:9.

3. The method of claim 2, wherein Zr is replaced partially or entirely with one of: Ti, Hf, Rf, and mixtures thereof.

4. The method of claim 1, wherein the alloy's bulk structure is one of: fully amorphous, fully crystalline, partially amorphous and partially crystalline.

5. The method of claim 1, wherein the alloy demonstrates volume loss of not more than 8.6×100 mm³ when subjected to a standard pin-on-disk wear resistance test.

6. The method of claim 1, wherein the atomic % of Z does not exceed 10%.

7. The method of claim 1, wherein the mechanical component is a gear.

8. The method of claim 7, wherein at least the teeth of the gear are formed from the material.

9. The method of claim 8, wherein the combined mass loss for two gears comprised of the same material and subjected to a “gear-on-gear” gear engaging test for up to 3 hours does not exceed 35.7 mg.

10. The method of claim 7, wherein the gear is selected from the group consisting of helical gear, double-helical gears, bevel gears, spiral bevel gears, hypoid gears, crown gears, worm gears, non-circular gears, rack and pinion gears, epicyclic gears, sun and planet gears, harmonic drive gears, and cage gears.

11. The method of claim 1, wherein the component is disposed within an oxygen-free environment.

12. The method of claim 1, wherein the component is disposed within a partial vacuum.

13-18. (canceled)
